(19) United States
(12) Patent Application Publication
(10) Pub. No.: US 2011/0169602 A1
(43) Pub. Date: Jul. 14, 2011

(54) SYSTEM AND METHOD FOR MONITORING PRODUCTS IN A DISTRIBUTION CHAIN

(76) Inventor: Gene F. GAFFNEY, Wantagh, NY (US)

(21) Appl. No.: 12/684,460

(22) Filed: Jan. 8, 2010

(51) Int. Cl. G05B 19/00; G06F 19/00; G06F 7/00

(52) U.S. Cl. 340/5.8; 235/385; 700/227

(57) ABSTRACT

In a product distribution system, a product with a product identification code (e.g., a serial number) is shipped between the different entities of a chain with a security label having a security label code. At each entity, the product can be authenticated by sending a query with the security label to the product source. At the product source, the received label code is compared to a label code stored in a database. Preferably the label codes are indexed with the product identification and if they match, a verification of authenticity is sent to the entity. In addition, if the entity desires to relabel the product before sending it on the chain, the source generates a new label code, stores the new label code so that it can be authenticated in the future and sends information to the entity for generating the new label with the new label code. The entity cannot generate or print a new label without receiving the label code from the source.

### RELATED APPLICATIONS

This subject matter of this application is related to the subject matter of commonly assigned application Ser. No. 11/678,318 entitled Method and System for Producing Certified Documents and the Like, which was filed on Feb. 23, 2007 and claims priority to provisional application Ser. No. 60/887,439 filed on Jan. 31, 2007, all incorporated herein, in their entirety.

### BACKGROUND OF THE INVENTION

1. Field of the Invention

This invention pertains to a method and system, wherein as objects are transmitted from the manufacturer, or other primary source, through various intermediaries including whole sellers and other entities that are involved in handling the objects either by reshipping them without performing any action on the objects, or by combining two or more objects to generate new objects, e.g., integrators. During the transmission, the objects are packaged or repackaged and tagged for verification and authentication purposes.

2. Description of the Prior Art

The present application pertains primarily to electronic items, parts and subassemblies originating from a single source and being transmitted between various intermediaries until they reach an end user. In the last twenty years it has been found that as various products, and especially computer and electronic parts, become desirable and are in high demand, they become targets of counterfeiting and other malfeasant practices. As a result, when an end user receives an expensive or highly desirable product, he would like to get some reassurance that the product is genuine and not a counterfeit or gray market product.

Similarly, both OEMs (original equipment manufacturers) and bona fide intermediaries have a strong interest in ensuring that the end users receive genuine products for several reasons. First and most important, counterfeit products equate to lost sales for both the OEM and the intermediaries. Second, counterfeit products are often poor in quality. Unless the end user can be convinced that he is not purchasing a counterfeit products he may have a bad opinion of the OEM. Third, if the end user returns the counterfeit product to the OEM, the OEM will have to choose between either replacing the product or suffering a loss of reputation.

While these problems are somewhat well known in the fields of consumer electronics, data processing, communications, etc., they also affect many other fields in which products from an OEM or other manufacturer enter the economic market and are distributed through normal distribution channels, including distributors at various levels in commerce and in various geographical areas. Thus, the s term ‘product’ is used herein to cover any and all equipment such as consumer, commercial or industrial equipment. Frequently this type of equipment consists of a plurality of modules that are made either by the same source, or a plurality of different sources. In general, it is believed that this problem is prevalent in any industry dealing with products produced in high volume and having a low or moderate price.

### SUMMARY OF THE INVENTION

Briefly, a method is presented herein for controlling the distribution of a product from a source through several distribution entities. Distribution entities form a distribution chain for the product, wherein the product is associated with a product identification code. The method includes receiving at a source, a query from each entity receiving the product, said query including a security label code from a security label associated with the received product; comparing the received security label code with a stored security label code from a data base; and if there is a match, a confirmation that the product is genuine may be sent to each entity.

Preferably, at least one entity sends the product to another of the entities using a new security label code. The stored new security label code is associated with the product identification code and any previous security label codes. In this instance, the new security label code is generated at the source and stored in a database, such as a table. Next, the new security label code is transmitted to the entity as part of a digital file. At the entity the digital file is used for printing a new security label with the new security label code. Each security label has built in security features to prevent counterfeiting. No entity within the system is allowed to print new labels without receiving the new security label code from the source.

Preferably the product is shipped along the chain in containers marked with the product identification code and the respective security label. The query includes the product identification code.

In order to implement this invention, at least some of the entities of the distribution chain employ a specialized label generator/decoder device. This device includes a controller; an input member coupled to said controller and receiving said original security label code; a communication port operated by the controller to send a query to the source, said query including said original label code, said communication port receiving a new security label code from the source if said original label code is genuine; and a printer operated by the controller to print a new security label, said new security label including said new security label code. Preferably, the original security label code on the original security label is in a machine-readable format, and the input member includes a scanner reading the original security label to detect said original label security code. The original security label code may be a bar code.

Preferably, the input member receives the identification code of the product and the query includes said identification code which is used at the source to match the security label codes.

The product identification code can be printed on the container, on the security label or on a separate plain label with the product identification appearing in alphanumeric characters and as a bar code.

In one embodiment the security label includes a security font image which is viewable only through an optical transparent detector. The detector is provided as part of the generator/reader device. The security font image can include or incorporate the security label code.

In other words, initially, at the source, a product with a product identification code, such as a serial number, is packaged in a box or another suitable container. A security label code is generated at the source and stored in a database. The security label code is indexed with the product identification code. Next, a security label bearing the security label code is generated and attached to the box. The security label code is presented on the security label in alphanumeric characters, bar codes and/or the security font image. The product identification code is also provided on the box, either by printing it straight on the box, by adding it to the security label or by printing a separate label.

The box is then shipped to other entities in the chain, each entity typically being found at different locations, respectively. At each of these locations, or entities, the product can be authenticated by contacting the source and sending to the source the received label code, preferably with the product code. The source then checks the received security label code with the stored label code and, if a match is found, generates an authentication message. Alternatively, if a new security label is required, the source generates a new label code and sends information to the entity that enables its device to print the new security label.

The security font image is used as a further way to identify or authenticate the box and its product.

In other embodiments, the integrator or other entity near the end of the distribution chain generates completely new labels having the characteristics described above, and other previous entities use other means of making sure that each package is correctly identified and that each package is identified and handled properly.

### BRIEF DESCRIPTION OF THE FIGURES

FIG. 1 shows a block diagram showing the product flow in accordance with the present invention;

FIG. 2 shows a block diagram of a device used to generate and/or check labels;

FIG. 3 shows a label generated in accordance with the invention and attached to respective boxes;

FIG. 4 shows a separate label with a serial number of the product;

FIG. 5 shows a flow chart for generating labels at the source; and

FIG. 6 shows a flow chart describing operation of the value added reseller.

### DETAILED DESCRIPTION OF THE INVENTION

As previously indicated, the present invention pertains to a system for tracking a product as it is shipped from its primary source to an end user. The primary source may be an original equipment manufacturer, an importer, etc. It is well known in the industry, that a product is inserted into an appropriate box. An appropriate box may be made of cardboard or other suitable material. According to this invention, two labels are attached to the box. Preferably, one of the labels is placed on a tear line, at the intersection between two opening flaps or some other similar location selected so that the box cannot be opened without ripping or otherwise destroying the label. Thus, at least one label is also used as a tamper indicator—if it is damaged or lost, the box has been tampered with. Alternatively, both labels can be attached at locations selected so the labels must be at least partially ripped or distorted, when the package is opened. In another embodiment of the invention, the labels are attached to the box, away from any seams, such as a side of the box, so that they remain integral when the box is opened.

Of course, it will be understood that for some products a cardboard box is not suitable and other types of containers or packaging may be used. The type of packaging may depend on many different factors, including, the nature of the product, the size and weight of the product, the method and venue used for shipping the product, legal regulations, costs, preferences of the source and/or the end user, and so forth. For example, the products can be bulky objects, or solids, liquids, pastes, etc., and may be shipped in bottles, pallets, bundles, etc. Moreover, for products in which no packaging is required, the label is attached directly to the product.

The two labels include a security label containing information and other indicia that authenticates the box and its contents and a plain label bearing the serial number of the product contained in the box, in plain text, bar code, and/or other known formats.

The labels are generated and/or read by respective label generator/reader device(s) at various locations within the system as discussed in more detail below. In the following description, boxes with products are generically identified by numeral 10, security labels by numeral 100, plain labels by numeral 110, and label generator/reader devices by numeral 150. A letter A, B, C, etc. is then added to these numerals when referring to respective elements produced at specific locations or when referring to an entity within the system.

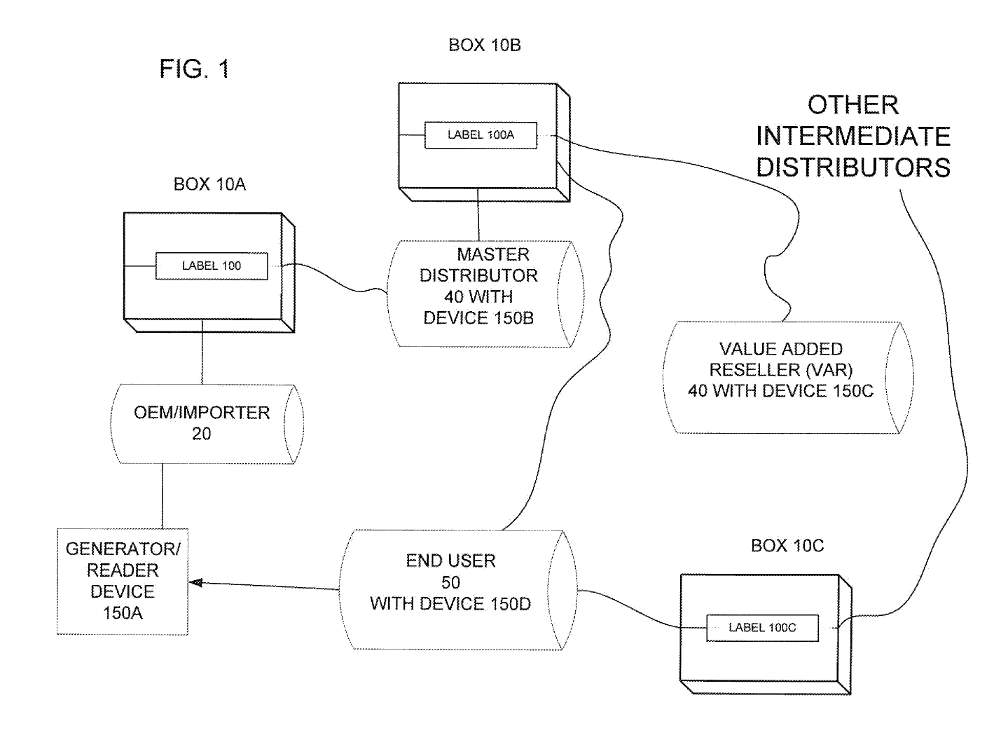

Starting with FIG. 1, a product is made or otherwise prepared for distribution at an originating source 20, such as an OEM (Original Equipment Manufacturer) or an importer. The product is placed in a box 10A and an appropriate security label 100A is prepared by label generator/reader 150A. Security label 100A is placed on box 10A. In addition, a standard label 110 is also printed and applied to box 10A either by the label generator/reader 150A or by a separate printer.

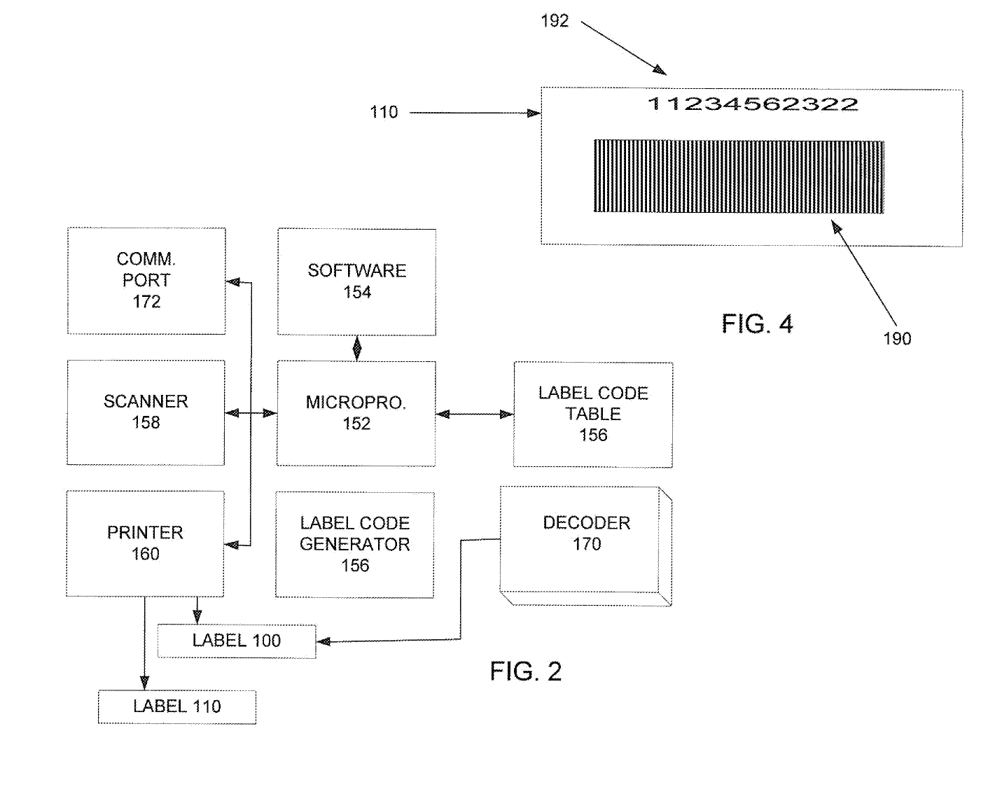

Each of the sites or locations in the system of FIG. 1 is provided with a respective label generator/reader device 150. A typical label generator/reader device 150 is shown in FIG. 2. Devices 150A-150D will have some of the elements shown in this Figure as discussed in more detail below. In FIG. 1, devices 150B, 150C and 150D are shown integrally within the master distributor 30, VAR 40 and end user 50 for the sake of clarity. Moreover, the labels 110 have been omitted from boxes 10A, 10B, 10C in FIG. 1, again for the sake of clarity.

The device 150 includes a microprocessor 152 operated under the control of software 154. The device 150 further includes a label code table 156, a scanner 158, security code generator 162 and a printer 164. The printer 160 prints labels 100, 110 that may then be applied to respective boxes 10. Labels 100 and 110 may have an adhesive on one side or an adhesive may be applied to them prior to being affixed to the respective box. The content of labels 100 and 110 may also be stored in a label code table 156. As shall become clear from the description below, only device 150A has label code table 156 and all the other devices must refer back to device 150A and source 20 for the respective information.

The device 150 further includes a decoder 170 used to decode or render visible a security font image on label 100, as discussed below. Alternatively, plain label 110 may be created by another printer (not shown).

Device 150 further includes a communication port 172 used to communicate and exchange information with other devices 150 within the system. Communication port 172 can also send and receive messages from the outside world, through the Internet, an Intranet, etc.

Device 150 may be implemented using a PC, a MAC, a laptop, etc.

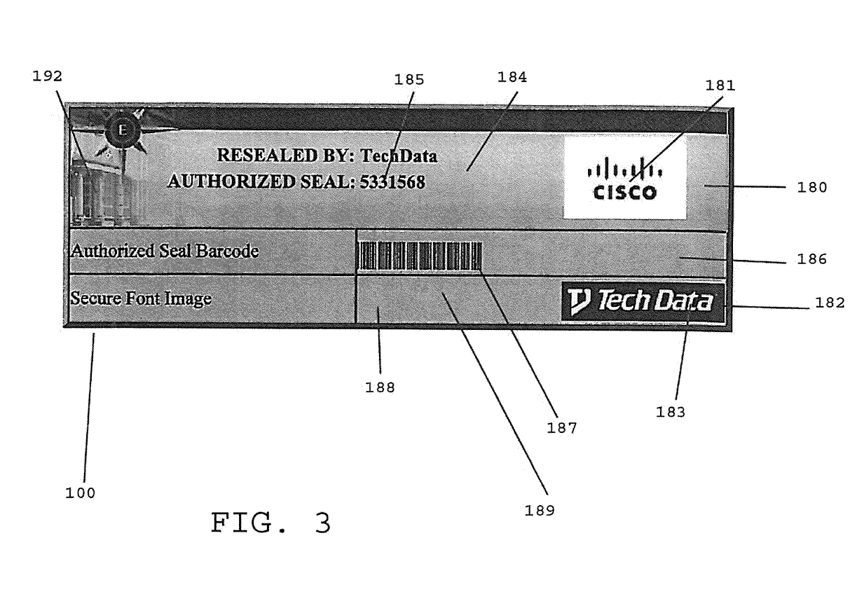

A typical label 100A, generated by device 150A at source 20, is shown in FIG. 3 and may include several fields, such as a first field 180 with alphanumeric characters 181 indicating the identity of the source 20 of the product, a field 182 with alphanumeric characters 183 indicating the name of the intended recipient of box 10A (e.g., a master distributor 30), a field 184 showing a label code 185 in plain text, a field 186 with a bar code 187 corresponding to the label code 185 and a field 188 with a security font image 189 generated from the label code 185. Typically, security font image 189 is generated from sets of parallel lines. Security font image 189 may be used as a background that extends along the whole or a major portion of the surface of label 100A, including behind bar code 187 in field 186. The label may further include various other elements, such as an image 182, which further provides a proof that box 10A is from a genuine source.

In one embodiment of the invention, security font image 189 includes or consists of alphanumeric characters corresponding to label code 185. As disclosed in more details in application Ser. No. 11/678,318, security font image 189 is generated from two sets of parallel lines disposed at an angle with respect to each other and having a certain predetermined pitch and line thickness. Detector 170 is used to detect security font image 189. For example, detector 170 may be a transparent flat piece of glass, plastic, or similar material having lines etched thereon (not shown). The lines have a pitch and thickness selected to render the security font visible when the decoder is placed on the label. Preferably, decoder 170 is made of glass, plastic or other transparent material and can be, for example, 2.5×3.5 in., though it could have other dimensions as well.

As shall become clear in the course of this description, preferably, the labels generated and printed at various locations are not identical but may include information specific or relevant to respective sites.

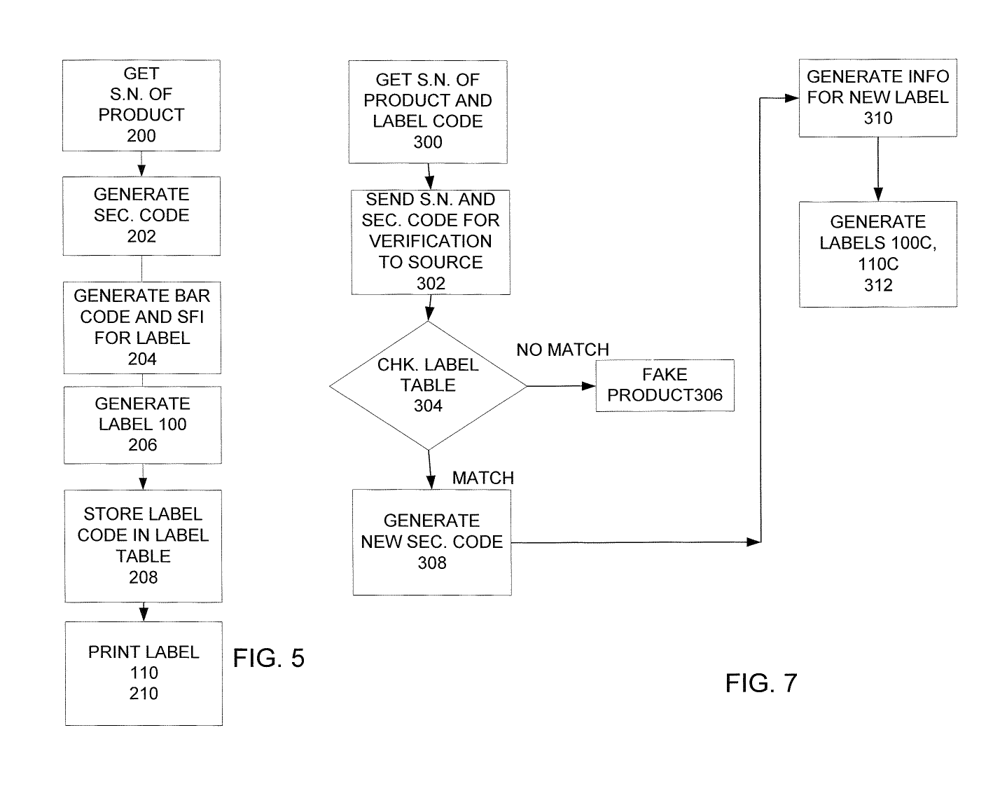

The process for generating label 100A is now described in conjunction with FIG. 5. First the product code (or serial number of the product) of box 100 is obtained. This serial number is known to source 20, assigned, or scanned in from a label on the product (not shown) using scanner 158. If more than one product is packed into box 100 then the serial number of each product is obtained.

Next, in step 202 a security code is generated using a random number generator or other similar means by security code generator 162. This security code becomes the label code 185 for label 100A. In step 204 the corresponding bar code 185 and the security font image 189 are generated.

In step 206 label 100A is printed using the codes from steps 202 and 204 and the label 100A is then attached to form the labeled box 10A.

In step 208 the contents of label 10A are stored in label code table 156, where the serial number of the product is indexed to the label code. Label code table 156 may also include other information, such as the intended designation of box 10A, e.g., master distributor 30 or VAR 40.

In step 210 plain label 110 is printed either by printer 160 or by another printer. Alternatively, plain label 100 can be printed directly on box 10A. As indicated in FIG. 4, typically, label 110 includes a series of numerals 192 and a corresponding bar code 190 that allows label 110 to be easily readable by a scanner (e.g., scanner 158). Of course, plain label 110 may be printed before the security label 100.

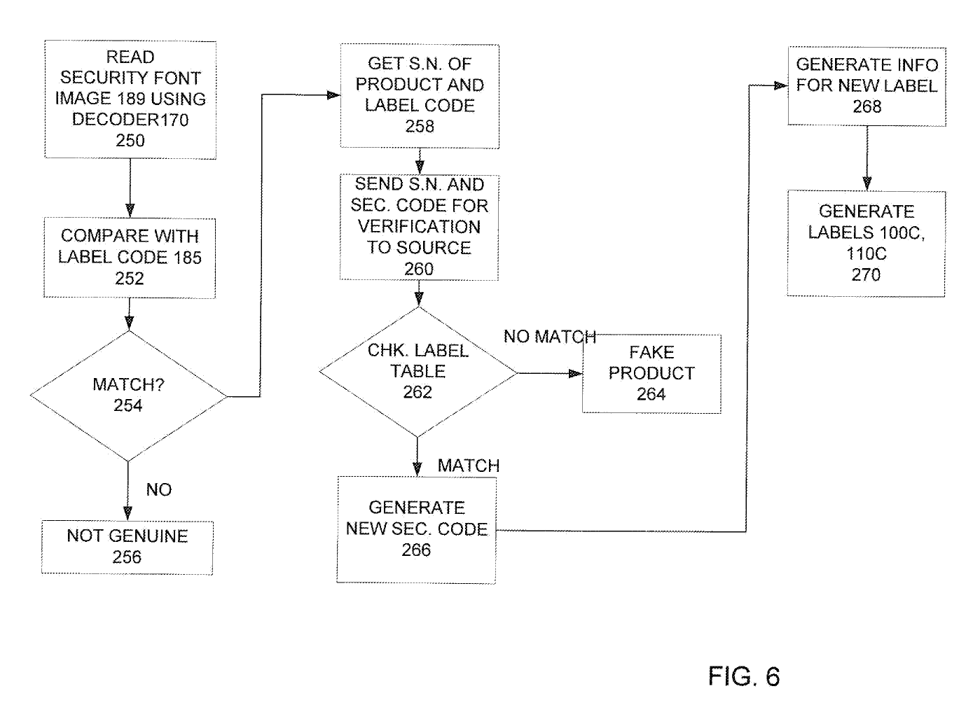

Labeled box 10A is then shipped via normal channels to a master distributor 30. The distributor now determines if box 10A is genuine, i.e., it has come from a genuine source. This process may take place on one or two stages and is now described in conjunction with FIG. 6. For the two stage process, the master distributor first checks if the label 100A is genuine. This is a manual process and consists of using decoder 170 to read security font image 189 (step 250). Once this image becomes visible, it is compared to label code 185 (step 252). If the numbers match (step 254) the box 10A (or at least label 100A) is probably genuine. If there is no match box 10A is probably from an unauthorized source (step 256).

The next stage is automatic and is implemented automatically between devices 150A, and 150B. In step 258, bar code 187 from label 100A, and bar code 190 from label 110 are read using scanner 158 in device 150B. These bar codes indicate the label code and the serial number of the product. In step 260, a query is sent by device 150B to device 150A. The query transmits the label number and the product serial number. In step 262, device 150A looks up these numbers in label code table 156. If the received data does not match the data in label code table 156, label 100A may not be genuine (step 264). If the data matches, label 100A is determined to be genuine. In step 266 the device uses the process outlined in FIG. 5 to generate a new label code, a new bar code and a new corresponding security font image. In step 268 the new code is stored together with an index to the serial number of the product in box 10A. In step 270 the information is sent to device 150B which then uses this information to print a new label 100B. It must be clarified that device 150B (or at least its software) is secured and preferably provided by source 20 so that master distributor 40 cannot operate device 150B in a manner as to produce a new label. A new label can be produced only when information and permission to generate a new label is obtained from device 150A.

Implicit in this entire exchange is the concept that the master distributor is asking for, and has received, verification that the product is genuine. In an alternate embodiment, creating a new label may not be important, or required, in which case, device 150B sends the query with the security label code and the product serial number. Device 150A compares the received codes with codes stored in its table. If there is a match, instead of the new label information, the device 150A transmits an acknowledgement verifying that the product is genuine.

Once label 100B is obtained, it can be attached to a box with the appropriate product.

In some cases, box 10A is not even opened by master distributor 30. Instead it is relabeled with a new security label 100B, and old label 110A is left on as well. It is advisable that old label 100A be removed if necessary to avoid confusion.

In other cases, master distributor 30 opens box 10A and repackages the product into a new box. This new box may contain only the same product, several different products, or only a portion of the original product found in box 10A. In this case, the master distributor can also decide to relabel the product within the box. Also, the master distributor generates a new label 110B to be placed outside box 10B. If a new serial number is assigned to the product in box 10B, then this new serial number may also be sent. If present, it is preferably sent as part of the query of step 260 to the source 20, so that this new serial number can be recorded in label code table 156.

In some instances, Box 10B is shipped to a value added reseller (VAR) 40. VAR 40 first checks box 10B to insure that it is genuine, using the same process as the master distributor.

First, label 10B, and especially field 188, is checked for security font image 189. In other words, decoder 170 of device 150C is placed on label 100A to render the security font images visible. As discussed above, the security font image is an image of alphanumeric characters that are identical to the label code 185. The security font image is compared to the label code. If they match, the label 100B is genuine. If they do not match, or more likely, if the security font message is missing, then label 100B, box 10B, and the corresponding product are fake or are gray market goods.

FIG. 7 shows the remaining automatic portion of the verification process. In step 300 the product serial number is obtained from label 110B or the product inside box 10B. The label code of label 100B is also obtained from field 186. Next, in step 302, the two codes are sent to device 150A. In step 304 the product serial number and label code are checked against the data in label code table 156. If there is no match, the label or box are not genuine (step 306). If they match, device 150A generates a new security code (step 308) and a new label code together with the other information required to make a new label (step 310). As with master distributor 30, VAR 40 may assign one or more new serial numbers for the product in box 10. These new serial numbers are also transmitted to device 150A which stores them with the label information in the label code table 156. In step 312 the new information is transmitted to device 150C which then generates the new labels for attachment to a new box with a modified product in the new box.

Typically once a product is received, VAR 40 performs some operations thereon to increase its value to end user 50. For example, box 10B may include computer equipment for an end user to perform certain specialized functions. VAR 40 opens the box 10B, checks the product, obtains software, additional equipment, and/or accessories (if necessary), and installs the new software and equipment into the product.

The VAR then packs the modified products in the new box 10C and labels it with labels 100C and 110C, which are generated as discussed above and in FIG. 6. The labeled box 10C is shipped to end user 50. Alternatively, the VAR 40 may send box 10C to other intermediate distributors who may pass the product from the VAR directly to the end user or to other intermediaries. For the sake of simplicity, it is assumed for the present description that the end user obtains a single product that can fit into a single box 10C. Of course, in many instances the end user may acquire many of the same or varying products that are all shipped in separate box 10s. In some cases the products may be small in which case several products may be shipped in a single box 10. In other cases, a product may be large and may include several components. In this case, each component is shipped in its own box.

In some instances, box 10B is shipped directly to end user 50. In some other instances, box 10A may be shipped directly to VAR 40. However, as will be seen in the following description, the principles of the invention remain the same regardless of which of the variations are used.

Once the end user receives a box (either 10B, or 10C), he verifies that it and the product contained therein are genuine as discussed above. For this purpose, the end user may also contact the source to obtain verification. At the source, all communications from other elements of the system are used to keep track of the shipped product by indexing the products by their respective serial numbers. As a result, the source can track and keep a record of all the shipped products, including all locations that each product has passed through or each location at which a product has been modified. This information may be important in detecting where fake or gray market products are distributed by others in the market.

In an alternate embodiment of the invention, the serial number of a product is provided on security label 100 and therefore, label 110 is not necessary. Moreover, while in the preferred embodiment, the product being distributed is identified by a serial number, it should be understood that other types of identification codes may be used to identify the product.

In the embodiments described above, as a product is being shipped from one entity to another, it is being labeled using generally the same techniques as discussed. However, the principles of this invention are also applicable to systems in which the security labels are generated only by some of the entities, e.g., the integrators while other entities use standard or other types of labels.

Obviously numerous modifications may be made to the invention without departing from its scope as defined in the attached claims.

We claim:

1. In a system for distributing a product between a source, at least an intermediary and an end user, wherein the intermediary receives the product in a sealed container, the sealed container holding the product associated with an identification code, the outside of the container having an original security label code, the original security label including an original security label code, a device comprising:
a controller;
an input coupled to said controller and receiving said original security label code;
a communication port operated by the controller to send a query to the source, said query including said original security label code, said communication port receiving a new security label code from the source if said original label code is genuine; and
a printer operated by said controller to print a new security label, said new security label including said new security label code.

2. The device of claim 1, wherein the original security label code on the original security label is in a machine-readable format and wherein said input member includes a scanner reading the original security label to detect said original security label code.

3. The device of claim 2, wherein said original security label code is a bar code and said scanner is a bar code scanner.

4. The device of claim 1, wherein said input member receives the identification code of said product and wherein said query includes said identification code.

5. The device of claim 4, wherein said original security label code and said identification code are in a bar code format.

6. The device of claim 5, wherein said input member includes a scanner reading said original security label code and said identification code.

7. The device of claim 4, wherein said identification code is printed on the container and wherein said printer prints a plain label with said identification code.

8. The device of claim 1, wherein the security label includes a security font image, said device further including an optical detector formed of a transparent material through which a user can view the security label to see the security font image.

9. The device of claim 8, wherein the security font image includes the original security label code.

10. The device of claim 1, wherein at the intermediary, the product is repackaged in a new container and wherein said printer prints said new label for attachment to the new container.

11. A method of distributing a product by a source, the product being identified by an identification code, comprising:
generating a security code for the product;
storing the security code and the associated identification code in a database;
shipping the product together with a security label, bearing the security code, to a remote location;
receiving from the remote location a request for authentication of the product, said request including the security code and the identification code;
comparing the received security code and received product identification with the stored security code and product identification code; and
sending a confirmation to the remote location, and authenticating the product if the stored security code and the received security code match.

12. The method of claim 11, further comprising packaging the product in a container, attaching the security label to the container and shipping the labeled container to the remote location.

13. The method of claim 12, further comprising incorporating the product identification code into the security label.

14. The method of claim 12, further comprising generating a plain label with the product identification code and attaching the plain label to the container prior to shipping.

15. The method of claim 11, further comprising generating said new security label code, storing said new security label code into said database, said new security label code being associated with said product identification code and sending label information to the remote location for generating the new security label with said new security label code.

16. The method of claim 11, further comprising generating a security font image for the security label, said security font image being visible only when viewed through a transparent decoder.

17. A method of controlling the distribution of a product from a source through several distribution entities, the entities forming a distribution chain for the product, wherein the product is associated with a product identification code, comprising:
receiving at the source a query from each entity receiving the product, said query including a security label code from a security label associated with the received product;
comparing the received security label code with a stored security label code from a data based using the product identification code; and
if the received security label code matches the stored security label code, sending to each entity, a confirmation that the product is genuine.

18. The method of claim 17, wherein the product is sent to another of the entities using a new label code, further comprising generating a new security label code by the source, storing said new security label code in the database, said stored new security label code being associated with the product identification code, and transmitting to a respective entity information for printing said new security label with said new security label code.

19. The method of claim 17, wherein said product is shipped along the distribution chain in containers marked with said product identification code and wherein said query includes said product identification code.

20. The method of claim 17, wherein the product identification code is a serial number assigned to the product.
